(19) United States
(12) Patent Application Publication
(10) Pub. No.: US 2024/0033855 A1
(43) Pub. Date: Feb. 1, 2024

(54) METHOD FOR MARKING ON RUBBER STOPPER

(71) Applicant: SAMSUNG MEDICAL RUBBER CO., LTD, Hwaseong-si Gyeonggi-do (KR)

(72) Inventor: Jae Hak CHUNG, Hwaseong-si (KR)

(73) Assignee: SAMSUNG MEDICAL RUBBER CO., LTD, Hwaseong-si Gyeonggi-do (KR)

(21) Appl. No.: 18/020,665

(22) PCT Filed: Mar. 5, 2021
(86) PCT No.: PCT/KR2021/002781

§ 371 Date: Feb. 10, 2023

(30) Foreign Application Priority Data
Aug. 17, 2020 (KR) 10-2020-0102905

(51) Int. Cl. B23K 26/359; B41M 1/32

(52) U.S. Cl. CPC B23K 26/359; B41M 1/32

(57) ABSTRACT

The present invention relates to a method for marking the surface of a rubber stopper with a character or numeral by irradiating the surface of the rubber stopper with a laser beam. According to the method of the present invention, there are advantages in that when a mark is made on a rubber stopper, foreign matter is not produced, deformation of the rubber stopper does not occur, and the mark is not erased or spread.

### TECHNICAL FIELD

The present invention relates to a method for marking a rubber stopper, and more particularly, to a method for marking the surface of a rubber stopper with letters or numbers by irradiating the surface of the rubber stopper with a laser.

### BACKGROUND ART

Pharmaceuticals are manufactured and distributed under strict good manufacturing practices (GMP) and pharmaceuticals for injections require special management. These pharmaceuticals should label raw materials and production history and must be accurately tracked. In addition, parts that come into direct contact with injections, such as rubber stoppers, must be managed and tracked in the same manner as pharmaceuticals.

In conventional rubber stoppers (rubber pads), the lot number is marked on the wrapping paper and is used to track the usage history of the customer in case of problems. However, in some demand sources, tracking is impossible due to the use of residue and mixed use of lot numbers. In order to solve this problem, there is a need for development of a printing method that enables tracking by directly printing the lot number and manufacturing code on the rubber stopper.

However, strict printing requirements to print the numbers or codes on the surface of rubber stoppers should be satisfied due to the nature of products used in pharmaceuticals, for example, foreign substances should not be peeled off from the surface, the marking should be not erased, and the rubber stopper should not be deformed by the marking. That is, the marked part on the rubber stopper should not be damaged and be visually identified even after cleaning and sterilization.

In addition, the performance of the rubber stopper after marking should conform to the performance standards for rubber for parenteral administration solution containers and powder and lyophilized powder containers in accordance with “Korean Pharmacopoeia General Test Method 32. Rubber Stopper Test Method for Infusion” and “European Pharmacopoeia (EP) 3.2.9 RUBBER CLOSURES FOR CONTAINERS FOR AQUEOUS PARENTERAL PREPARATIONS, FOR POWDERS AND FOR FREEZE-DRIED POWDERS”.

### DISCLOSURE

### Technical Problem

It is an object of the present invention to develop and provide a method of marking a rubber stopper that prevents foreign substances from being generated when marking the rubber stopper, and avoids deformation of the rubber stopper and removal or smearing of the marking.

### Technical Solution

In accordance with an aspect of the present invention, the above and other objects can be accomplished by the provision of a method of marking a letter or number on a surface of a rubber stopper by irradiating the surface of the rubber stopper at a power of 10 to 16 W with a short pulse laser having a pulse width of 2 to 6 ns and a peak power of 75 to 125 kW.

The letter or number is preferably marked on the front or rear surface of the rubber stopper.

The rubber stopper may be, for example, a drug bottle cap or a syringe nozzle cover.

### Advantageous Effects

The method of marking letters or numbers on rubber stoppers according to the present invention has effects of preventing generation of foreign substances, deformation of the rubber stopper and removal or smearing of the marking.

### DESCRIPTION OF DRAWINGS

FIG. 1 illustrates a principle of laser marking.

FIG. 2 is a schematic diagram illustrating an example of physical processing by laser marking.

FIG. 3 is a printing test using a YVO₄ hybrid laser method and a CO₂ fiber laser method according to the present invention.

FIG. 4 shows the result of comparison in the peak power and pulse width between the YVO₄ hybrid laser method of the present invention and the CO₂ fiber laser method.

FIG. 5 shows the results of laser-marking rubber stoppers using the YVO₄ hybrid laser according to the present invention and the CO₂ fiber laser.

FIG. 6 shows the result of marking a red rubber stopper using the YVO₄ hybrid laser according to the present invention.

FIG. 7 shows the result of marking a gray rubber stopper using the YVO₄ hybrid laser of the present invention.

FIG. 8 is a schematic diagram of the structure of the YVO₄ hybrid laser (S-MOPA) used in the present invention.

### BEST MODE

Rubber stoppers used for medical purposes must not generate any foreign substances when marking letters or numbers thereon in the final product finishing stage. In addition, deformation of the rubber stopper due to marking should not occur. In addition, the markings must neither be erased nor smudged. In this regard, the marking method of the present invention was found to satisfy all of the above requirements. Based thereon, the present invention has been completed.

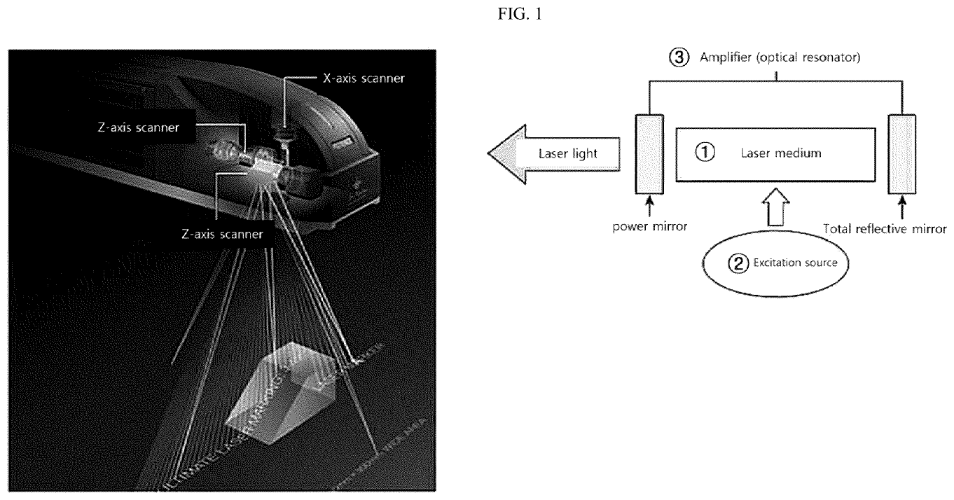

The marking using laser light is performed as shown in FIG. 1. Briefly, the laser light is amplified while reciprocating between the reflective mirrors in the oscillator. The amplified laser light is emitted from the mirror on the power part and focused on the surface of the target object (rubber stopper in the present invention) through the fθ lens. Letters or numbers can be marked by moving each scanner in the X, Y, and Z axes to the focused point. FIG. 1 shows the principle of laser marking.

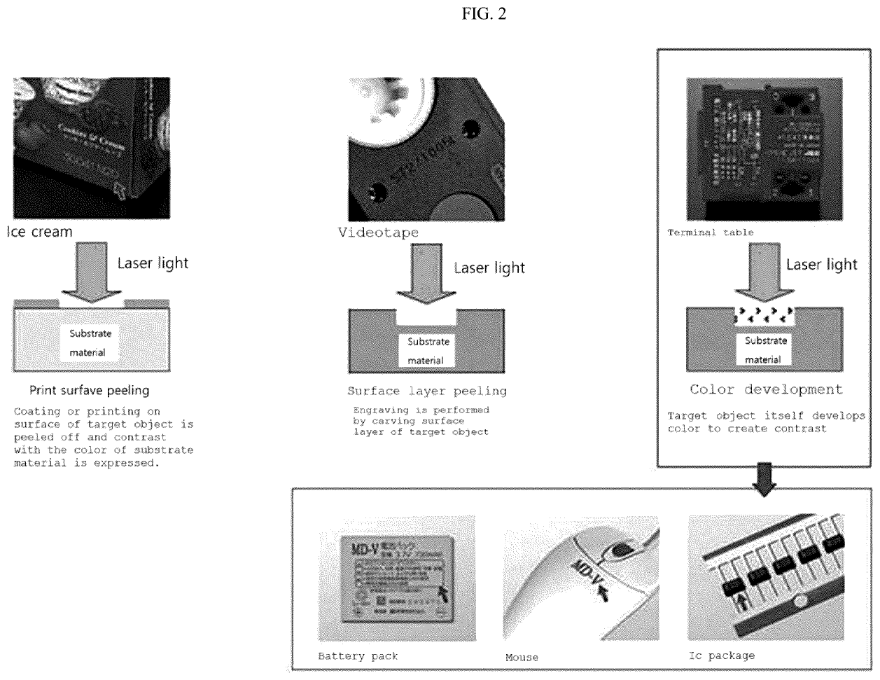

Laser marking is semipermanent in general circumstances because physical processing such as “engraving” or “coloring” is performed on a target object. The details of the physical processing using a laser marking machine are shown in Table 1 below. In addition, FIG. 2 is a schematic diagram illustrating an example of physical processing.

TABLE 1
Example of physical processing using
laser marking machine

| | Main material for target |
|---|---|
| Processing details | object |
| Surface melting | Resin |
| Burning | Paper, resin |
| Surface layer peeling | Plated metal, printed paper |
| off | |
| Surface oxidation | Metal |
| Trimming | Glass, metal |
| Discoloring | Resin |

The present invention provides a method of marking a letter or number on a surface of a rubber stopper by irradiating the surface of the rubber stopper with a short pulse laser having a pulse width of 2 to 6 ns and a peak power of 75 to 125 kW at a power of 10 to 16 W.

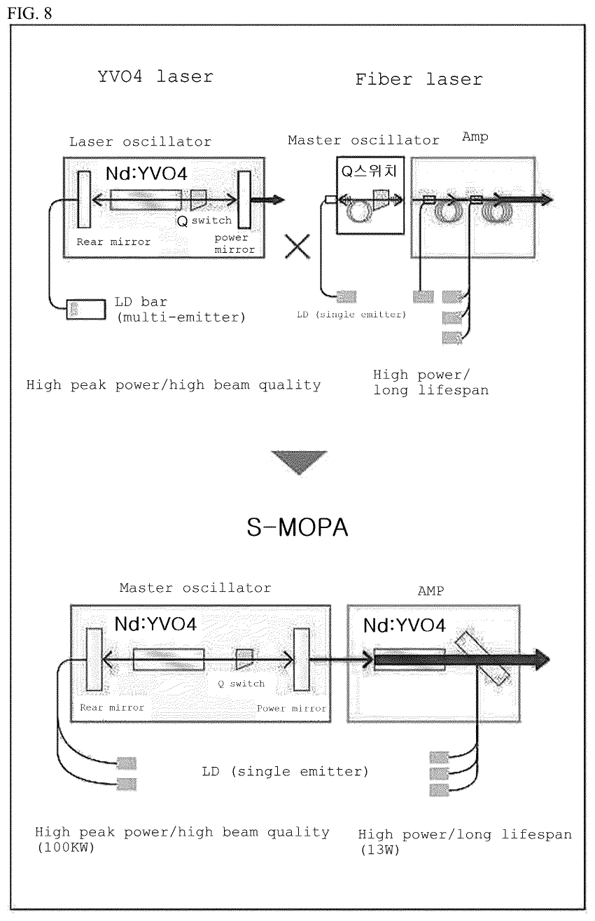

A YVO₄ hybrid laser (S-MOPA) is preferably used as the laser in the present invention. This is a combination of a YVO₄ laser and a fiber laser to provide the advantages of both lasers. An S-MOPA (solid-state master oscillator power amplifier) adopts the high-quality beam of the YVO₄ laser oscillator and combines the same with the amplifier used in fiber lasers to realizes high power. In addition, a single emitter with high heat dissipation is selected as a light source, LD (laser diode), to provide a long lifespan. FIG. 8 is a schematic diagram illustrating the structure of the YVO₄ hybrid laser (S-MOPA) used in the present invention.

The result of the following test showed that the marking method according to the present invention performs marking while decolorizing the existing color of the surface of the rubber stopper. The result showed that there was neither generation of foreign matter nor deformation of the outer appearance of the rubber stopper. In addition, the result showed that color bleeding did not occur.

Meanwhile, in the rubber stopper marking method of the present invention, the rubber stopper marking method may be used to mark various surfaces of the rubber stopper. Preferably, letters or numbers may be marked on the front or rear surface of the rubber stopper.

In addition, the rubber stopper according to the present invention can be utilized in various applications and, for example, a drug bottle cap or a syringe nozzle cover. The drug bottle should satisfy various requirements (e.g., effects of preventing generation of foreign matter, and preventing deformation and tampering with printed letters or numbers) because it is used for drugs. In this regard, the present invention can satisfy such requirements.

In addition, the rubber stopper is preferably a synthetic rubber containing isobutene as a main raw material. More preferably, the rubber stopper is IIR (isobutylene-isoprene rubber), so-called “butyl rubber”, obtained by copolymerizing a small amount of isoprene with isobutene. When the laser printing method of the present invention is applied to butyl rubber, butyl rubber can be marked with letters or numbers while decolorizing the resin. Therefore, generation of foreign matter, deformation of the rubber stopper, and discoloration did not occur, as can be seen from the test of the present invention. Therefore, irradiating with the laser of the present invention based on these aspects is optimal.

Hereinafter, the present invention will be described in more detail with reference to the following examples and experimental examples, but the scope of the present invention is not limited to the examples and experimental examples, and includes variations and technical concepts equivalent thereto.

### Example 1: Rubber Stopper Marking and Test According to ‘YVO₄ Hybrid Laser Method’ of the Present Invention

In this embodiment, a rubber stopper was marked using a YVO₄ hybrid laser (S-MOPA) (the laser used herein is an “MD-X1000” model manufactured by “Keyence Korea www.keyence.co.kr”). Specifically, letters or numbers were marked on the surface of the rubber stopper by irradiating the surface of medical rubber made of an IIR (isobutylene-isoprene rubber) material at a power of 13 W with a short pulse laser having a pulse width of 4 ns and a peak power of 100 kW, as a YVO₄ hybrid laser (S-MOPA).

Meanwhile, for comparison, a rubber stopper was marked using a conventional CO₂ fiber laser. Letters or numbers were marked on the surface of the rubber stopper by irradiating the surface of a medical rubber stopper made of isobutylene-isoprene rubber (IIR) with a laser having a pulse width of 100 ns at a power of 30 W.

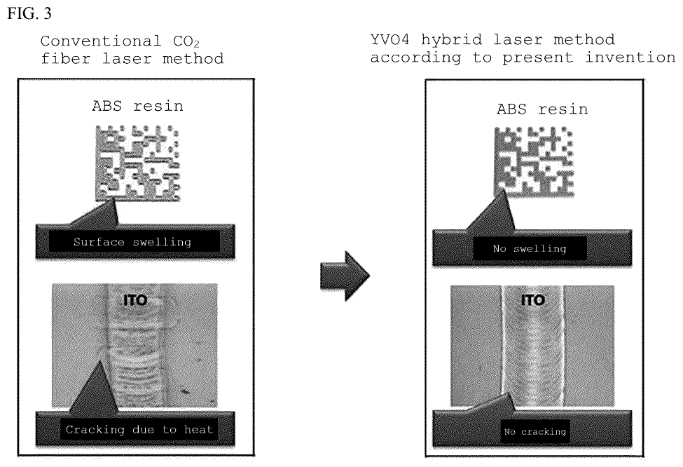

FIG. 3 shows the result of the test. As can be seen from FIG. 3, the method of the present invention caused neither swelling nor cracking when printing on the rubber stopper.

This indicates that the method of the present invention can prevent swelling of the resin, which is a raw material, in the rubber stopper to be printed, and thereby improve visibility. In addition, it can also be seen that cracking or product defects due to the heat effect could be reduced.

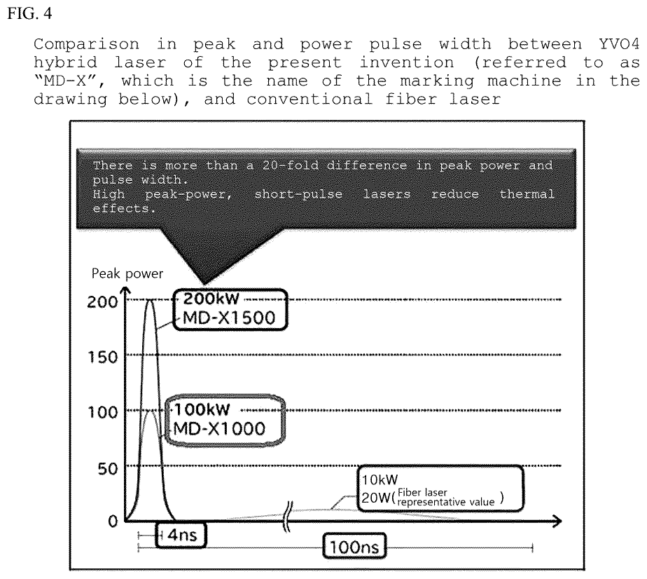

There is a difference of more than 20 times in peak power and pulse width between the YVO₄ hybrid laser method of the present invention and the CO₂ fiber laser method. The YVO₄ hybrid laser method of the present invention using a high-peak-power, short-pulse laser minimizes the thermal effects on the surface of the rubber stopper, causing the difference in effects (FIG. 4).

Meanwhile, based on the above results, two laser marking methods, that is, marking methods based on the YVO₄ hybrid laser and the CO₂ fiber laser, were applied to actual rubber stoppers.

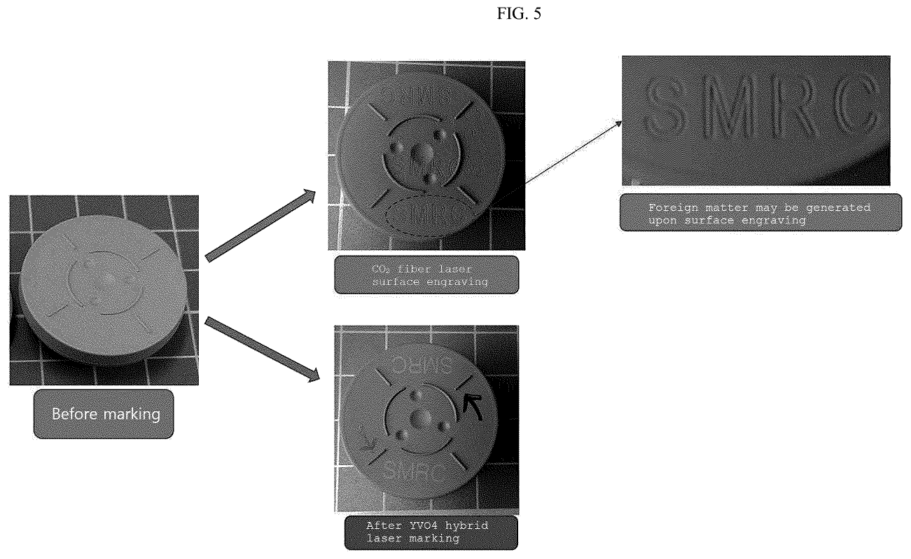

The result is shown in FIG. 5. As can be seen from FIG. 5, the CO₂ fiber laser method may cause generation of foreign matter when engraving is performed using a surface engraving method. However, the YVO₄ hybrid laser method of the present invention caused neither surface damage nor peeling off upon hand scratching. In terms of the printed form, the existing color was bleached during marking. There were neither foreign matter nor scratches in the marked area.

### Example 2: Marking of Red Rubber Stoppers Using YVO₄ Hybrid Laser Method of Present Invention

Based on the test results of Example 1, a red rubber stopper (IIR, isobutylene-isoprene rubber) was marked using the YVO₄ hybrid laser method of the present invention. The test was performed under the same conditions as in Example 1 above.

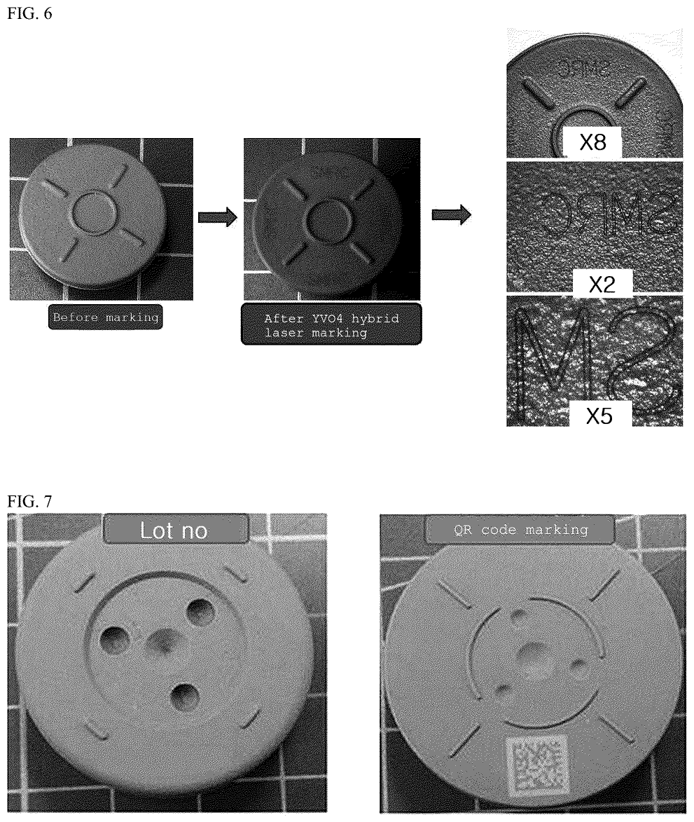

The test results are shown in FIG. 6. As can be seen from FIG. 6, there was no damage to the surface of the marked part. In terms of the printed form, the existing color was bleached while marking, like Example 1. There were neither foreign matter nor scratches in the marked area.

### Example 3: Marking of Gray Rubber Stopper Using YVO₄ Hybrid Laser Method of Present Invention

Based on the test results of Example 1, a gray rubber stopper (IIR, isobutylene-isoprene rubber) was marked using the YVO₄ hybrid laser method of the present invention. The test was performed under the same conditions as in Example 1 above.

The test results are shown in FIG. 7. As can be seen from FIG. 7, there was no damage to the surface of the part marked with Lot No. or QR code. There were neither foreign matter nor scratches in the marked area.

1. A method of marking a letter or number on a surface of a rubber stopper by irradiating the surface of the rubber stopper at a power of 10 to 16 W with a short pulse laser having a pulse width of 2 to 6 ns and a peak power of 75 to 125 kW.

2. The method according to claim 1, wherein the letter or number is marked on a front or rear surface of the rubber stopper.

3. The method according to claim 1, wherein the rubber stopper is a drug bottle cap or a syringe nozzle cover.
